(19) United States
(12) Patent Application Publication
(10) Pub. No.: US 2003/0171702 A1
(43) Pub. Date: Sep. 11, 2003

(54) Massage applicator for cosmetic compositions

(75) Inventors: Guy Thompson, Inverness, IL (US); Wendi Hutchinson, Chicago, IL (US); Thomas Wiegner, Saint Charles, IL (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/374,480

(22) Filed: Feb. 26, 2003

Related U.S. Application Data
(63) Continuation-in-part of application No. 10/085,602, filed on Feb. 27, 2002.

(51) Int. Cl. A61H 23/02; B43K 5/02

(52) U.S. Cl. 601/72; 601/17; 401/143

(57) ABSTRACT

A specially adapted kit apparatus (10) and method for delivering a cosmetic composition (12) to human skin which provides enhanced skin benefit efficacy. The kit includes the cosmetic composition and a massage applicator apparatus (14). The method consists of massaging a cosmetic composition into human skin using the specially adapted kit (10).

### BACKGROUND OF THE INVENTION

1. Field of the Invention

The present invention relates to an improved apparatus and method for dispensing cosmetic compositions, and more particularly, to an apparatus and method for dispensing a cosmetic composition using a massage applicator.

2. The Related Art

Cosmetic compositions are dispensed in a variety of packages that are commercially available or otherwise known in the art. These products are designed to provide skin benefits including moisturization, anti-aging, color, odor and perspiration control, oil and sebum control, skin lightening, sun protection and combinations of such benefits.

An object of the present invention is to provide a specially adapted kit for delivering a cosmetic composition which provides enhanced benefit efficacy of the composition.

Another object of the present invention is to provide a method for delivering a cosmetic composition to human skin for enhanced benefit efficacy of the composition.

Other objects of the present invention will become apparent to those skilled in the art by reference to the specification.

As used herein, the term “massage” includes manipulation of tissues (as by rubbing, kneading, vibrating, or tapping) with the hand or an instrument for therapeutic, experiential, sensorial, or cosmetic purposes.

### SUMMARY OF THE INVENTION

The present invention is based on the concept that, if application of a cosmetic composition is combined with massage, significantly improved functionality is achieved. Therefore, a specially adapted kit apparatus for delivering a cosmetic composition for topical application to human skin and a method of using it is provided, including:

a) a massage applicator apparatus comprising a power source, which may include manual generation of vibrationary action, driving an oscillating mechanism connected to an interface medium;

the massage applicator apparatus further including means for delivering vibration to the interface medium;

the interface medium optionally being provided with a cover seatable thereon; and

b) a cosmetic composition stored within the apparatus.

The power source may include an on and off control device and a switch. The applicator surface may have proturberances thrusting out from its outer surface. The massage applicator apparatus may further include a composition refill system and/or a composition delivery system.

### BRIEF DESCRIPTION OF THE DRAWINGS

The following figure is intended for purposes of illustration and example.

FIG. 1 is a perspective view of an embodiment of the present invention;

FIG. 2 is a cross-sectional view of the embodiment of FIG. 1 taken along line II-II.

### DETAILED DESCRIPTION OF THE INVENTION

The present invention relates to a specially adapted kit apparatus and method for delivering a cosmetic composition to human skin which provides enhanced effects. Kit 10 includes a cosmetic composition 12 and a massage applicator apparatus 14. Cosmetic composition 12 may either be provided within and as a component of massage applicator apparatus 14 or separately applied from a base unit either directly to human skin or to massage applicator apparatus 14. Cosmetic composition 12 may be any cosmetic composition suitable for application to human skin. Preferably, cosmetic composition 12 is a cream or soft solid.

Massage applicator 14 can be in any form, operated manually, mechanically, such as clockwork mechanisms, or driven by a power source, such as electrical or battery source, and other mechanisms for the generation of vibration, such as electromagnetic solenoids and magneto restrictive materials. Preferably, massage applicator 14 is a hand held apparatus including a power source 20 driving an oscillating mechanism 30 connected to a vibrating head or interface medium 40. Massage applicator 14 can further optionally include a composition refill system 50, a composition delivery system 60 for delivering composition 12 to interface medium 40, and means for delivering vibration 70 (also known as a flexible skirt), for actuating vibration of interface medium 40. Cover 80 is optionally provided, seatable over interface medium 40 to enclose and protect massage applicator apparatus 14.

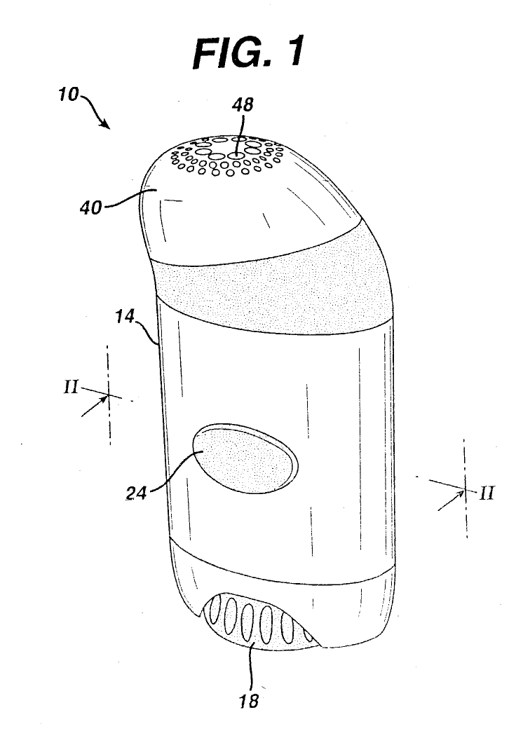

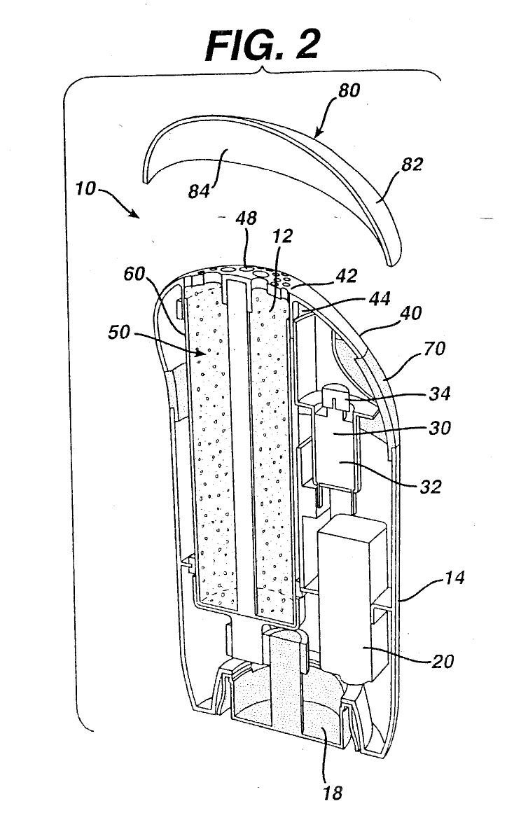

Referring to the accompanying drawings, FIG. 1 is a perspective view of a preferred embodiment of kit 10 of the present invention and FIG. 2 is a cross-sectional view of the embodiment of FIG. 1 taken along line II-II. In the preferred embodiment, kit 10 includes cosmetic composition 12 and massage applicator 14. Massage applicator 14 includes power source 20 driving an oscillating mechanism 30 connected to interface medium 40.

Power source 20 may include permanently or detachably installed disposable or re-chargeable batteries. Power source 20 may further include an on and off control device 22 (not shown), including a switch 24. Control device 22 may control power source 20 to operate for a set time or continuously. Optionally, control device 22 may simultaneously control power to oscillating mechanism 30 and to composition delivery system 60.

Oscillating mechanism 30 may be powered or manual, and may include an electrical mechanism, a motor, a solenoid, clockwork, and the like. Oscillating mechanism 30 provides vibration to interface medium 40 at set or variable frequencies and amplitude. Oscillating mechanism may further include offset weights 34.

Interface medium 40 may be formed integrally with oscillating mechanism 30 or may be formed as a separate member and attached to oscillating mechanism 30. Interface medium 40 includes an applicator outer surface 42 extending in a direction away from oscillating mechanism 30 and an inner surface 44 closest to oscillating mechanism 30. Outer surface 42 may be smooth or textured, and curved or flat. A textured outer surface 42 may have proturberances 46 thrusting out therefrom, which may be rounded masses or knobs (not shown). Interface medium 40 optionally has at least one exit orifice 48 therein.

In another aspect, composition 12 may be a solid stick composition with the solid stick composition itself serving as interface medium and applicator surface. Thereby, the vibration or resonance may be transferred directly to the skin via the stick.

Further with reference to FIGS. 1 and 2, massage applicator 14 includes a composition refill system 50 in fluid communication with a composition delivery system 60 for delivering composition 12 to interface medium 40, and means for delivering vibration 70, for actuation of vibration of interface medium 40. Composition refill system 50 may include a refillable or disposable container, sachet, or combinations thereof. For example, when the contents of the container or sachet are exhausted, it may be replaced by another container or sachet. In the alternative, the container may be refilled from an external source of composition 12.

In the preferred embodiment, composition delivery system 60 may be provided with a pump system or a platform lift system. Composition delivery system 60 may include an actuating device for dispensing a dose of composition 12 to interface medium 40. Delivery system 60 may be automatically or manually driven.

Cover 80 may be provided, to be seated over interface medium 40 to enclose any exit orifices 48 when massage applicator apparatus 14 is not in use. Cover 80 includes outer surface 82 and inner surface 84 which takes an appropriate form to cooperate with applicator outer surface 42.

During operation of kit 10, with reference to FIG. 1, composition 12 is delivered to human skin according to the present invention by means of massage applicator apparatus 14 by turning on switch 24 to activate power source 20. Control device 22 may control power source 20 to operate for a set time or continuously. Power is delivered to oscillating mechanism 30 activating means for delivering vibration 70 (also known as a flexible skirt) to interface medium 40, thereby causing interface medium 40 to vibrate. In the meantime, composition delivery system 60 delivers composition 22 from product refill system 50 to exit orifices 48 in the vibrating interface medium 40. Massage applicator apparatus 14 is brought in contact with a location on human skin at applicator outer surface 42, thereby simultaneously exerting stress and strain or delivering a massage and composition 12 through exit orifices 48 to the point of contact on the skin. Thereby, composition 12 is spread and massaged into the human skin. Massage as used in the context of the present invention is meant to include manipulation of human tissues, as by rubbing, kneading, or tapping, be it manually or with the aid of an apparatus.

### Compositions

The present invention kit 10 is particularly suitable for flowable compositions, preferably in cream form.

Compositions of this invention will include a cosmetically acceptable carrier. Amounts of the carrier may range from 1 to 99.9%, preferably from about 70 to about 95%, optimally from about 80 to about 90%. Among the useful carriers are water, emollients, fatty acids, fatty alcohols, humectants, thickeners and combinations thereof. The carrier may be aqueous, anhydrous or an emulsion. Preferably the compositions are aqueous, especially water and oil emulsions of the W/O or O/W or triplex W/O/W variety. Water when present may be in amounts ranging from about 5 to about 95%, preferably from about 20 to about 70%, optimally from about 35 to about 60% by weight.

Emollient materials may serve as cosmetically acceptable carriers. These may be in the form of silicone oils, synthetic esters, hydrocarbons, fatty alcohols and acids, humectants and thickeners. Amounts of the emollients may range anywhere from about 0.1 to about 95%, preferably between about 1 and about 50% by weight.

Silicone oils may be divided into the volatile and nonvolatile variety. The term “volatile” as used herein refers to those materials which have a measurable vapor pressure at ambient temperature. Volatile silicone oils are preferably chosen from cyclic (cyclomethicone) or linear polydimethylsiloxanes containing from 3 to 9, preferably from 4 to 5, silicon atoms.

Nonvolatile silicone oils useful as an emollient material include polyalkyl siloxanes, polyalkylaryl siloxanes and polyether siloxane copolymers. The essentially nonvolatile polyalkyl siloxanes useful herein include, for example, polydimethyl siloxanes with viscosities of from about 5×10⁻⁶ to 0.1 m²/s at 25 C. Among the preferred nonvolatile emollients useful in the present compositions are the polydimethyl siloxanes having viscosities from about 1×10⁻⁵ to about 4×10⁻⁴ m²/s at 25 C.

Another class of nonvolatile silicones are emulsifying and non-emulsifying silicone elastomers. Representative of this category is Dimethicone/Vinyl Dimethicone Crosspolymer available as Dow Corning 9040, General Electric SFE 839, and Shin-Etsu KSG-18. Silicone waxes such as Silwax WS-L (Dimethicone Copolyol Laurate) may also be useful.

Among the ester emollients are:

(1) Alkenyl or alkyl esters of fatty acids having 10 to 20 carbon atoms. Examples thereof include isoarachidyl neopentanoate, isononyl isonanonoate, oleyl myristate, oleyl stearate, and oleyl oleate.

(2) Ether-esters such as fatty acid esters of ethoxylated fatty alcohols.

(3) Polyhydric alcohol esters. Ethylene glycol mono and di-fatty acid esters, diethylene glycol mono- and di-fatty acid esters, polyethylene glycol (200-6000) mono- and di-fatty acid esters, propylene glycol mono- and di-fatty acid esters, polypropylene glycol 2000 monooleate, polypropylene glycol 2000 monostearate, ethoxylated propylene glycol monostearate, glyceryl mono- and di-fatty acid esters, polyglycerol poly-fatty esters, ethoxylated glyceryl mono-stearate, 1,3-butylene glycol monostearate, 1,3-butylene glycol distearate, polyoxyethylene polyol fatty acid ester, sorbitan fatty acid esters, and polyoxyethylene sorbitan fatty acid esters are satisfactory polyhydric alcohol esters. Particularly useful are pentaerythritol, trimethylolpropane and neopentyl glycol esters of C₁-C₃₀ alcohols.

(4) Wax esters such as beeswax, spermaceti wax and tribehenin wax.

(5) Sterols esters, of which cholesterol fatty acid esters are examples thereof.

(6) Sugar ester of fatty acids such as sucrose polybehenate and sucrose polycottonseedate.

Hydrocarbons which are suitable cosmetically acceptable carriers include petrolatum, mineral oil, C₁₁-C₁₃ isoparaffins, polyalphaolefins, and especially isohexadecane, available commercially as Permethyl 101A from Presperse Inc.

Fatty acids having from 10 to 30 carbon atoms may also be suitable as cosmetically acceptable carriers. Illustrative of this category are pelargonic, lauric, myristic, palmitic, stearic, isostearic, hydroxystearic, oleic, linoleic, ricinoleic, arachidic, behenic and erucic acids.

Fatty alcohols having from 10 to 30 carbon atoms are another useful category of cosmetically acceptable carrier. Illustrative of this category are stearyl alcohol, lauryl alcohol, myristyl alcohol and cetyl alcohol.

Humectants of the polyhydric alcohol-type can be employed as cosmetically acceptable carriers. Typical polyhydric alcohols include glycerol, polyalkylene glycols and more preferably alkylene polyols and their derivatives, including propylene glycol, dipropylene glycol, polypropylene glycol, polyethylene glycol and derivatives thereof, sorbitol, hydroxypropyl sorbitol, hexylene glycol, 1,3-butylene glycol, isoprene glycol, 1,2,6-hexanetriol, ethoxylated glycerol, propoxylated glycerol and mixtures thereof. The amount of humectant may range anywhere from 0.5 to 50%, preferably between 1 and 15% by weight of the composition.

Thickeners can be utilized as part of the cosmetically acceptable carrier of compositions according to the present invention. Typical thickeners include crosslinked acrylates (e.g. Carbopol 982®), hydrophobically-modified acrylates (e.g. Carbopol 1382®), cellulosic derivatives and natural gums. Among useful cellulosic derivatives are sodium carboxymethylcellulose, hydroxypropyl methocellulose, hydroxypropyl cellulose, hydroxyethyl cellulose, ethyl cellulose and hydroxymethyl cellulose. Natural gums suitable for the present invention include guar, xanthan, sclerotium, carrageenan, pectin and combinations of these gums. Inorganics may also be utilized as thickeners, particularly clays such as bentonites and hectorites, fumed silicas, and silicates such as magnesium aluminum silicate (Veegum®). Amounts of the thickener may range from 0.0001 to 10%, usually from 0.001 to 1%, optimally from 0.01 to 0.5% by weight.

Cosmetic compositions of the present invention may be in any form. These forms may include lotions, creams, roll-on formulations, sticks, mousses, aerosol and non-aerosol sprays.

Surfactants may be present as a skin benefit agent in cosmetic compositions of the present invention. Total concentration of the surfactant when present may range from about 0.1 to about 40%, preferably from about 1 to about 20%, optimally from about 1 to about 5% by weight of the composition. The surfactant may be selected from the group consisting of anionic, nonionic, cationic and amphoteric actives. Particularly preferred nonionic surfactants are those with a C₁₀-C₂₀ fatty alcohol or acid hydrophobe condensed with from 2 to 100 moles of ethylene oxide or propylene oxide per mole of hydrophobe; C₂-C₁₀ alkyl phenols condensed with from 2 to 20 moles of alkylene oxide; mono- and di-fatty acid esters of ethylene glycol; fatty acid monoglyceride; sorbitan, mono- and di-C₈-C₂₀ fatty acids; and polyoxyethylene sorbitan as well as combinations thereof. Alkyl polyglycosides and saccharide fatty amides (e.g. methyl gluconamides) are also suitable nonionic surfactants.

Preferred anionic surfactants include soap, alkyl ether sulfates and sulfonates, alkyl sulfates and sulfonates, alkylbenzene sulfonates, alkyl and dialkyl sulfosuccinates, C₈-C₂₀ acyl isethionate, C₈-C₂₀ alkyl ether phosphates, C₈-C₂₀ sarcosinates and combinations thereof.

Sunscreen benefit agents may be included in compositions of the present invention. Particularly preferred are such materials as ethylhexyl p-methoxycinnamate, available as Parsol MCX®, Avobenzene, available as Parsol 1789® and benzophenone-3, also known as Oxybenzone. Inorganic sunscreen agents may be employed such as microfine titanium dioxide, zinc oxide, polyethylene and various other polymers. Amounts of the sunscreen agents when present may generally range from 0.1 to 30%, preferably from 2 to 20%, optimally from 4 to 10% by weight.

Preservatives can desirably be incorporated into the cosmetic compositions of this invention to protect against the growth of potentially harmful microorganisms. Suitable traditional preservatives for compositions of this invention are alkyl esters of para-hydroxybenzoic acid. Other preservatives which have more recently come into use include hydantoin derivatives, propionate salts, and a variety of quaternary ammonium compounds. Cosmetic chemists are familiar with appropriate preservatives and routinely choose them to satisfy the preservative challenge test and to provide product stability. Particularly preferred preservatives are phenoxyethanol, methyl paraben, propyl paraben, imidazolidinyl urea, sodium dehydroacetate and benzyl alcohol. The preservatives should be selected having regard for the use of the composition and possible incompatibilities between the preservatives and other ingredients in the emulsion. Preservatives are preferably employed in amounts ranging from 0.01% to 2% by weight of the composition.

Compositions of the present invention may include such benefit agents as vitamins. Illustrative vitamins are Vitamin A (retinol), Vitamin B₂, Vitamin B₆, Vitamin C, Vitamin E and Biotin. Derivatives of the vitamins may also be employed. For instance, Vitamin C derivatives include ascorbyl tetraisopalmitate, magnesium ascorbyl phosphate and ascorbyl glycoside. Derivatives of Vitamin E include tocopheryl acetate, tocopheryl palmitate and tocopheryl linoleate. DL-panthenol and derivatives may also be employed. Total amount of vitamins when present in compositions according to the present invention may range from 0.001 to 10%, preferably from 0.01% to 1%, optimally from 0.1 to 0.5% by weight.

Another type of benefit agent can be that of an enzyme such as oxidases, proteases, lipases and combinations. Particularly preferred is superoxide dismutase, commercially available as Biocell SOD from the Brooks Company, USA.

Skin lightening compounds may be included as benefit agents in the compositions of the invention. Illustrative substances are placental extract, lactic acid, niacinamide, arbutin, kojic acid, ferulic acid, resorcinol and derivatives including 4-substituted resorcinols and combinations thereof. Amounts of these agents may range from about 0.1 to about 10%, preferably from about 0.5 to about 2% by weight of the compositions.

Desquamation promoters may be present as benefit agents. Illustrative are the alpha-hydroxycarboxylic acids and beta-hydroxycarboxylic acids. The term “acid” is meant to include not only the free acid but also salts and C₁-C₃₀ alkyl or aryl esters thereof and lactones generated from removal of water to form cyclic or linear lactone structures. Representative acids are glycolic, lactic and malic acids. Salicylic acid is representative of the beta-hydroxycarboxylic acids. Amounts of these materials when present may range from about 0.1 to about 15% by weight of the composition.

A variety of herbal extracts may be included as benefit agents in compositions of this invention. Illustrative are green tea, chamomile, licorice and extract combinations thereof. The extracts may either be water soluble or water-insoluble carried in a solvent which respectively is hydrophilic or hydrophobic. Water and ethanol are the preferred extract solvents.

Also included may be such benefit agents as lipoic acid, retinoxytrimethylsilane (available from Clariant Corp. under the Silcare 1M-75 trademark), dehydroepiandrosterone (DHEA) and combinations thereof. Ceramides (including Ceramide 1, Ceramide 3, Ceramide 3B and Ceramide 6) as well as pseudoceramides may also be utilized by for many compositions of the present invention. Amounts of these materials may range from about 0.000001 to about 10%, preferably from about 0.0001 to about 1% by weight.

Colorants, fragrances, opacifiers and abrasives may also be included as benefit agents in compositions of the present invention. Each of these substances may range from about 0.05 to about 5%, preferably between 0.1 and 3% by weight.

Antiperspirant and deodorant benefit agents may also be utilized for compositions according to the present invention. Examples of suitable antiperspirant and deodorant agents include aluminium salts, zirconium salts, aluminium and/or zirconium complexes, for example aluminium halides, aluminium hydroxy halides, zirconyl oxyhalides, zirconyl hydroxyhalides, and mixtures thereof. Specific examples include activated aluminium chlorohydrate, aluminium chlorohydrate, aluminium pentachlorohydrate and aluminium zirconium chlorohydrate. Useful zirconium salts include zirconium hydroxy-chloride and zirconium oxychloride. Preferred agents include ZAG (Zirconium Aluminium Glycine), AAZG (Activated Aluminium Zirconium Glycine), and AACH (Activated Aluminium Chorohydrate). The antiperspirant benefit agent can be present in particulate form whereupon it is normally suspended in a suitable carrier fluid, which usually is water-immiscible, and which can be structured or thickened. Alternatively the agent can be dissolved in a polar solution, such as for example in aqueous solution or in a polar low weight polyhydric alcohol such as propylene glycol, advantageously about 30% to about 60% by weight solution.

Deodorant benefit agents according to the present invention normally comprise about 0.01 to about 90% of the cosmetic composition. The deodorant benefit agent can be alcohols, in particular aliphatic monohydric alcohols such as ethanol or propanol, antimicrobial actives such as polyhexamethylene biguanides, e.g., those available under the trade name Cosmocil™ or chlorinated aromatics, e.g., triclosan available under the trade name Irgasan™, non-microbiocidal deodorant actives such as triethylcitrate, bactericides and bacteriostats. Yet other deodorant actives can include zinc salts such as zinc ricinoleate.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material ought to be understood as modified by the word “about”.

The following examples will more fully illustrate the embodiments of this invention. All parts, percentages and proportions referred to herein and in the appended claims are by weight unless otherwise illustrated.

### EXAMPLE 1

A typical cosmetic cream according to the present invention is outlined under Table I.

TABLE I

| | |
|---|---|
| INGREDIENT | WEIGHT % |

PHASE A

| | |
|---|---|
| Water | Balance |
| Disodium EDTA | 0.05 |
| Methyl Paraben | 0.15 |
| Magnesium Aluminum Silicate | 0.60 |
| Triethanolamine | 1.20 |

PHASE B

| | |
|---|---|
| Xanthan Gum | 0.20 |
| Natrosol ® 250HHR (ethyl cellulose) | 0.50 |
| Butylene Glycol | 3.00 |
| Glycerin | 2.00 |

PHASE C

| | |
|---|---|
| Sodium Stearoyl Lactylate | 0.10 |
| Glycerol Monostearate | 1.50 |
| Stearyl Alcohol | 1.50 |
| Isostearyl Palmitate | 3.00 |
| Silicone Fluid | 1.00 |
| Cholesterol | 0.25 |
| Sorbitan Stearate | 1.00 |
| Butylated Hydroxy Toluene | 0.05 |
| Vitamin E Acetate | 0.01 |
| PEG-100 Stearate | 2.00 |
| Stearic Acid | 3.00 |
| Propyl Paraben | 0.10 |
| Parsol MCX ® | 2.00 |
| Caprylic/Capric Triglyceride | 0.50 |
| Hydroxycaprylic Acid | 0.01 |
| C12-15 Alkyl Octanoate | 3.00 |

PHASE D

| | |
|---|---|
| Vitamin A Palmitate | 0.10 |
| Bisabolol | 0.01 |
| Vitamin A Acetate | 0.01 |
| Fragrance | 0.03 |
| Retinol 50C | 0.02 |

### EXAMPLE 2

A water-in-oil topical liquid make-up foundation utilizing the dispensing apparatus of the present invention is described in Table II below.

TABLE II

| | |
|---|---|
| INGREDIENT | WEIGHT % |

PHASE A

| | |
|---|---|
| Cyclomethicone | 9.25 |
| Cetyl Octanoate | 2.00 |
| Dimethicone Copolyol | 20.00 |

PHASE B

| | |
|---|---|
| Talc | 3.38 |
| Pigment (Iron Oxides) | 10.51 |
| Spheron L-1500 (Silica) | 0.50 |

PHASE C

| | |
|---|---|
| Synthetic Wax Durachem 0602 | 0.10 |
| Arachidyl Behenate | 0.30 |

PHASE D

| | |
|---|---|
| Cyclomethicone | 1.00 |
| Trihydroxystearin | 0.30 |

PHASE E

| | |
|---|---|
| Laureth-7 | 0.50 |
| Propyl Paraben | 0.25 |

PHASE F

| | |
|---|---|
| Fragrance | 0.05 |

PHASE G

| | |
|---|---|
| Water | balance |
| Methyl Paraben | 0.12 |
| Propylene Glycol | 8.00 |
| Niacinamide | 4.00 |
| Glycerin | 3.00 |
| Sodium Chloride | 2.00 |
| Sodium Dehydroacetate | 0.30 |

### EXAMPLE 3

Illustrated herein is another skin cream dispensed by packaging according to the present invention.

TABLE III

| INGREDIENT | WEIGHT % |
|---|---|
| Glycerin | 6.93 |
| Niacinamide | 5.00 |
| Permethyl 101A¹ | 3.00 |
| Sepigel 305² | 2.50 |
| Q2-1403 | 2.00 |
| Isopropyl Isostearate | 1.33 |
| Arlatone 2121⁴ | 1.00 |
| Cetyl Alcohol CO-1695 | 0.72 |
| SEFA Cottonate⁵ | 0.67 |
| Tocopherol Acetate | 0.50 |
| Panthenol | 0.50 |
| Stearyl Alcohol | 0.48 |
| Titanium Dioxide | 0.40 |
| Disodium EDTA | 0.10 |
| Glydant Plus⁶ | 0.10 |
| PEG-100 Stearate | 0.10 |
| Stearic Acid | 0.10 |
| Purified Water | Balance |

¹Isohexadecane, Presperse Inc., South Plainfield, NJ
²Polyacrylamide(and)C13-14 Isoparaffin(and) Laureth-7, Seppic Corporation, Fairfield, NJ
³dimethicone(and)dimethiconol, Dow Corning Corp. Midland, MI
⁴Sorbitan Monostearate and Sucrococoate, ICI Americas Inc., Wilmington, DE
⁵Sucrose ester of fatty acid
⁶DMDM Hydantoin (and) lodopropynyl Butylcarbamate, Lonza Inc., Fairlawn, NJ

### EXAMPLE 4

Illustrative of a powdered cosmetic composition dispensed by the apparatus according to the present invention is the formula of Table IV.

TABLE IV

| INGREDIENT | WEIGHT % |
|---|---|
| Polysilicone-11 | 34.5 |
| Cyclomethicone | 54 |
| Petrolatum | 11 |
| Dimethicone Copolyol | 0.5 |

### EXAMPLE 5

A relatively anhydrous composition dispensed by the massaging dispenser according to the present invention is reported in Table V.

TABLE V

| INGREDIENT | WEIGHT % |
|---|---|
| Cyclomethicone | 80.65 |
| Dimethicone | 9.60 |
| Squalane | 6.00 |
| Isostearic Acid | 1.90 |
| Borage Seed Oil | 0.90 |
| Retinyl Palmitate | 0.25 |
| Ceramide 6 | 0.10 |
| Tocopherol | 0.10 |

### EXAMPLE 6

The following table lists examples of cream and soft solid antiperspirant and/or deodorant compositions suitable for use with the massage apparatus of the present invention. These examples are by way of illustration only and are not meant to be limiting in any way.

TABLE VI

| Creams and soft solids | 10.1 | 10.2 | 10.3 | 10.4 | 10.5 | 10.6 | 10.7 | 10.8 | 10.9 | 10.1 | 10.11 | 10.12 | 10.13 |
|---|---|---|---|---|---|---|---|---|---|---|---|---|---|
| ingredients | | | | | | | | | | | | | |
| Silicone wax | | 2.5 | | | | 3 | | | | | | | |
| N-lauroyl-glutamic acid | | | | 1 | | | | | | | | | |
| di-n-butylamide | | | | | | | | | | | | | |
| Cetearyl Dimethicone/vinyl | | | | | | | | | | | | | 65.05 |
| dimethoicone crosspoiymer | | | | | | | | | | | | | |
| and Cyclopentasiloxane | | | | | | | | | | | | | |
| Syncrowax ERLC (13) | | | 2.5 | | 5 | | | | | | | 3.75 | |
| Synchrowax HGL-C | | | | | 1.25 | | | | | | | | |
| Castor wax | | | 7.5 | | | | | 4 | | | | 1.25 | |
| Triacontenyl vinyl | 5 | | | | | | | | | | | | |
| pyrrolidone copolymer | | | | | | | | | | | | | |
| Stearyl alcohol | | | | | | | | 6 | | | | | |
| Paraffin wax | 5 | 7.5 | | | | | | | | | | | |
| Candelilla wax | | | | | | | | | 7 | | | | |
| C24/28 alkyl dimethicone wax | | | | | | | | | 3.5 | | | | |
| Silica | | | 1 | | | 1.5 | 1.5 | | | | | | 0.2 |
| Talc | | | | | 1.75 | | 6 | 5 | | | | | |
| Hydrohobic Clay Bentone 38 | | | | | | | 3 | | 0.5 | | | | |
| Anhydrous aluminium silicate | | | | | | | 6 | | | | | | |
| Microthene powder | | | | | | | 6 | | | | | | |
| Propylene Carbonate | | | | | | | 1.5 | | | | | | |
| Cyclomethicone | | 64.5 | | | 61.5 | 63.5 | 38.3 | 59 | 46 | 50.8 | | | |
| Tetraphenyl tetramethylsiloxane | | | | 53 | | | | | | | | | |
| C12-15 Alkyl benzoate | 64.5 | | 63.5 | | | 10 | | | | 12.7 | 63.5 | 64.5 | 4 |
| Dextrin palmitate | | | | 5 | | | | | | 10 | 10 | 5 | |
| Octyldodecanol | | | | 15 | | | | | | | | | |
| Isopropyl Myristate | | | | | | | | | | | | | |
| Neopentyl Glycol Diheptanoate | | | | | | | | | | | | | 5 |
| PPG14 Butyl ether | | | | | | | | 4.5 | | | | | |
| Dimethicone 10 cSt | | | | | 5 | | 10 | | | | | | |
| Dimethicone 350 cst | | | | | | | | | 25 | | | | |
| PEG8 distearate | | | | | | | | | | | | | 2 |
| Stearyl dimethicone | | | | | | | | | | | | | 0.75 |
| POE 100 stearyl ether | | | | | | | 2 | | | | | | |
| POE 100 stearate | | | | | | | | 1 | | | | | |
| PPG1-PEG9-lauryl glycol ether | | | | | | | | | | | | | 2 |
| AACH | 25 | 25.5 | | | | 22 | | | | | | 25.5 | |
| Milledn AACH | | | 25.5 | 25.5 | | | | | | | 26 | | |
| ACH | | | | | | | | | 18 | | | | |
| AZAG 7167 | | | | | 25 | | 25.7 | 20 | | 26.5 | | | 22.5 |
| Fragrance | 0.5 | | | 0.5 | 0.5 | | | 0.5 | | | 0.5 | | 0.5 |

### Clinical Studies

Clinical studies have shown increased efficacy in sweat reduction, quicker drying and less stickiness using kit 10 including massage applicator apparatus 14 for delivering antiperspirant/deodorant composition 12 to the human axilla. Although not wishing to be bound by theory, one hypothesis is that the apparatus and method for applying antiperspirant or deodorant compositions opens up more or additional, dormant, skin pores, which may not be otherwise open at the time an antiperspirant and/or deodorant composition 12 would otherwise be applied. In theory, only about one third of the sweat glands in a given area are open at any one time, while two thirds are shut. The massage technique of the present invention makes more sweat glands available for accepting delivery of a cosmetic antiperspirant or deodorant composition, thereby achieving higher sweat reduction. In combination, massage applicator apparatus 14 and composition 12, constituting kit 10 of the present invention, are more efficacious than either component alone.

### EXAMPLE 7

This example summarises the results of a 5-day Antiperspirant Efficacy Study (Hotroom Test). The study was performed to investigate how varying the method of product application of delivering antiperspirant to the axilla will affect efficacy. Two product application techniques were compared: applying antiperspirant composition 12 using massage applicator apparatus 14 versus applying antiperspirant composition 12 via its standard pack. The soft solid antiperspirant composition 12 as outlined in Table VII was tested using an art-recognized gravimetric procedure.

TABLE VII

| Raw Material | Weight % |
|---|---|
| Cyclopentasiloxane | 43.98 |
| C30-C45 Alkyl Dimethicone | 6.00 |
| Hydrogenated Castor Oil | 6.00 |
| Dimethicone | 10.00 |
| Talc | 8.00 |
| Aluminum Zirconium Trichiorohydrex GLY | 25.50 |
| Fragrance | 0.50 |
| Antioxidant | 0.02 |

The differences between the two product application techniques are shown in the Table VIII below.

TABLE VIII
% DIFFERENCE

| | | Appl 2 | Appl 3 | Appl 4 |
|---|---|---|---|---|
| Sample Comparisons | | 1 hour | 1 hour | 24 hour |
| A-test) Product | % Difference | 12% | 6.6% | 10% |
| Application using a | Lower 95% CL | 1.9% | −2.3% | 0.81% |
| Massager (low speed) | Upper 95% CL | 21% | 15% | 19% |
| B-control) Product | | | | |
| Application using | | | | |
| Standard Tap-38 soft | p-value | 0.02 | 0.13 | 0.04 |
| Solid pack | | | | |

These results indicate that product application technique using massage apparatus 14 was significantly better (p<0.05) at post treatment sweat collections 1-hour after the second product application and 24-hours after the fourth product application. The results show a synergy between massage apparatus 14 and composition 12.

What is claimed is:

1. A kit for delivering a cosmetic composition for topical application to human skin comprising:
a) a massage applicator apparatus comprising a power source driving an oscillating mechanism connected to an interface medium;
said massage applicator apparatus further comprising means for delivering vibration to said interface medium;
said interface medium having at least one exit orifice therein; and
b) a cosmetic composition stored within the apparatus.

2. The package of claim 1 wherein said power source comprises an on and off control device.

3. The kit of claim 1 wherein said power source comprises a switch.

4. The kit of claim 1 wherein said interface medium comprises an applicator outer surface and an inner surface;
and wherein said applicator surface comprises protuberances thrusting out therefrom.

5. The kit of claim 1 further comprising a composition refill system.

6. The kit of claim 1 further comprising a composition delivery system.

7. The kit of claim 1 further comprising a cover seatable over said interface medium.

8. A method of delivering a cosmetic composition for topical application to human skin comprising the use of a kit comprising:
a) a massage applicator apparatus comprising a power source driving an oscillating mechanism connected to an interface medium;
said massage applicator apparatus further comprising means for delivering vibration to said interface medium; and
b) a cosmetic composition stored within the apparatus.

9. The method of claim 8 further comprising controlling said power source using an on and off control device provided therefor.

10. The method of claim 8 wherein said power source comprises a switch for turning said power source on and off.

11. The method of claim 8 wherein said interface medium comprises an applicator outer surface and an inner surface;
wherein said applicator surface comprises proturberances thrusting out therefrom.

12. The method of claim 8 wherein said kit further comprises a composition refill system.

13. The method of claim 8 wherein said kit further comprises a composition delivery system.

14. The method of claim 8 wherein said kit further comprises a cover seatable over said interface medium.

15. A method of delivering a cosmetic composition for topical application to human skin comprising the use of a kit comprising:
a) a massage applicator means for delivering massage to said skin; and
b) a cosmetic composition stored within the apparatus means.

16. The method of claim 15, wherein said massage applicator means comprising an interface medium, wherein the geometry of said interface medium is selected from the group consisting of an interface medium that is substantially smooth, an interface medium comprising proturberances thrusting out therefrom, and combinations thereof.
